(19) United States
(12) Patent Application Publication
(10) Pub. No.: US 2023/0196212 A1
(43) Pub. Date: Jun. 22, 2023

(54) AUTONOMOUS VEHICLE DESTINATION DETERMINATION

(71) Applicant: GM Cruise Holdings LLC, San Francisco, CA (US)

(72) Inventor: Alexander Willem Gerrese, San Francisco, CA (US)

(73) Assignee: GM Cruise Holdings LLC, San Francisco, CA (US)

(21) Appl. No.: 17/555,495

(22) Filed: Dec. 19, 2021

(51) Int. Cl. G06Q 10/02; G06Q 50/30; G08G 1/00; B60W 60/00; G05D 1/02; G06F 16/587

(52) U.S. Cl. CPC G06Q 10/02; B60W 60/00256; G05D 1/0246; G05D 1/0291; G06F 16/587; G06Q 50/30; G08G 1/202; G05D 2201/0213

(57) ABSTRACT

Systems and methods are provided for determining an autonomous vehicle destination based on an image. In particular, systems and methods are provided for receiving an input image and determining a user’s pick-up location, drop-off location, and/or stop location based on the image-based input. In various implementations, the systems and methods disclosed herein eliminate the need for a user to explicitly input an address to hail a ride.

### FIELD OF THE DISCLOSURE

The present disclosure relates generally to autonomous vehicles (AVs) and to image-based systems and methods for determining pick-up and drop-off locations.

### BACKGROUND

Autonomous vehicles, also known as self-driving cars, driverless vehicles, and robotic vehicles, are vehicles that use multiple sensors to sense the environment and move without human input. Automation technology in the autonomous vehicles enables the vehicles to drive on roadways and to accurately and quickly perceive the vehicle’s environment, including obstacles, signs, and traffic lights. The vehicles can be used to pick up passengers and drive the passengers to selected destinations. The vehicles can also be used to pick up packages and/or other goods and deliver the packages and/or goods to selected destinations.

Generally, when a user would like an autonomous vehicle to pick them up at a specified location, a mobile device of the user (e.g., a smartphone) receives input from the user indicative of the specified pick-up location (e.g., an address) and a desired location for drop-off. Alternatively, the mobile device may use GPS and/or employ a geocoding system to ascertain the specified pick-up location. The mobile device causes data indicative of the specified pick-up location to be received by the autonomous vehicle, and the autonomous vehicle then generates and follows a route to the specified pick-up location based upon the data. Once at the specified pick-up location, the user may enter the autonomous vehicle and the autonomous vehicle may then transport the user to the drop-off location.

Using an address and/or a geocoding system to specify a pick-up location and a drop-off location for an autonomous vehicle has various deficiencies. For example, a user typically does not memorize addresses, and as such, the user may more easily recognize locations in terms of human sensory factors such as sight or sound. To illustrate, the user may frequent a coffee shop, but may not be aware of the address of the coffee shop. Instead, the user may remember that the coffee shop is located on his or her commute to work on the left-hand side of a particular street. Moreover, if the user is in an unfamiliar region, then the user may be unaware of information pertaining to his or her current location beyond information received from his or her senses.

### SUMMARY

Systems and methods are provided for determining an autonomous vehicle destination based on an image. In particular, systems and methods are provided for a user’s pick-up location, drop-off location, and/or stop location to be determined based on an image-based input. In various implementations, the systems and methods disclosed herein eliminate the need for a user to explicitly input an address to hail a ride.

According to one aspect, a method for determining a vehicle destination comprises receiving a ride request including an input image, wherein the input image corresponds to one of a pick-up location, a stop location, and a drop-off location; searching an image database for an entry matching the input image; identifying the entry matching the input image, wherein the entry includes a corresponding location; and determining an input image location based on the corresponding location.

In some implementations, identifying the image entry matching the input image comprises: identifying a plurality of image entries matching the input image and a corresponding plurality of entry locations, wherein each of the plurality of image entries includes a respective entry location from the corresponding plurality of entry locations, and further comprising transmitting the plurality of entry locations to a ridehail application. In various examples, a ridehail service can be used to order an individual ride, to order a pooled rideshare ride, and to order a vehicle to deliver a package.

In some implementations, the method further comprises receiving a first selection from the plurality of entry locations, wherein the first selection is the input image location. In some implementations, the method further comprises requesting an additional input image. In some implementations, the method further comprises transmitting a request for confirmation of the input image location to a ridehail application. In some implementations, the method further comprises dispatching an autonomous vehicle to a ride request pick-up location. In some implementations, receiving a ride request comprises receiving a package delivery request.

According to another aspect, a system for determining vehicle destination, comprises an online portal configured to receive a ride request including an input image, wherein the input image corresponds to one of a pick-up location, a stop location, and a drop-off location; an image database including image entries with corresponding locations; and a central computer configured to receive the ride request, search the image database for a first image entry matching the input image, identify the first image entry and first corresponding location, and determine an input image location based on the first corresponding location.

In some implementations, the central computer is further configured to: identify a first plurality of image entries matching the input image and a corresponding first plurality of entry locations, wherein each of the first plurality of image entries includes a respective entry location from the corresponding first plurality of entry locations, and transmit the first plurality of entry locations to the online portal. In some implementations, the online portal is further configured to receive a first selection from the first plurality of entry locations, wherein the first selection is the input image location.

In some implementations, the central computer is further configured to request an additional input image via the online portal. In some implementations, the central computer is further configured to request confirmation of the input image location via the online portal. In some implementations, the central computer is further configured to dispatch an autonomous vehicle to the pick-up location. In some implementations, the ride request comprises a package delivery request. In some implementations, the system further comprises an autonomous vehicle configured to capture a plurality of photos while driving and transmit the photos to the central computer, wherein each of the plurality of photos is entered into the image database.

According to another aspect, a system for determining vehicle destinations in an autonomous vehicle fleet, comprises a plurality of autonomous vehicles, each configured to capture a plurality of photos with corresponding photo locations; an image database configured to store each of the plurality of photos and corresponding photo locations as image entries; and a central computer configured to: receive a ride request including an input image, wherein the input image corresponds to one of a pick-up location, a stop location, and a drop-off location; search the image database for a first image entry matching the input image; and identify the first image entry and a first corresponding location, and determine an input image location based on the first corresponding location.

In some implementations, the image database is further configured to store the input image and the input image location. In some implementations, the central computer is further configured to route a first autonomous vehicle from the plurality of autonomous vehicles to the input image location. In some implementations, the central computer receives the ride request from a ridehail application, and wherein the central computer is further configured to transmit a request for an additional input image to the ridehail application. In some implementations, the central computer receives the ride request from a ridehail application, and wherein the central computer is further configured to request confirmation of the input image location via the ridehail application.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

To provide a more complete understanding of the present disclosure and features and advantages thereof, reference is made to the following description, taken in conjunction with the accompanying figures, wherein like reference numerals represent like parts, in which:

FIG. 1 is a diagram illustrating an autonomous vehicle, according to some embodiments of the disclosure;

FIG. 2 is a flow chart illustrating a method for a ridehail service to determine an autonomous vehicle destination, according to some embodiments of the disclosure;

FIG. 3 is a flow chart illustrating a method for a user to request a ride using an input image for a location via a ridehail application, according to some embodiments of the disclosure;

FIG. 4 is a flow chart illustrating a method for a ridehail application to receive and transmit a ride request including an input image for a pick-up and/or drop-off location, according to some embodiments of the disclosure;

FIGS. 5A-5C show examples of an interface for a ridehail service showing a ride request with image-based location determination, according to some embodiments of the disclosure;

FIG. 6 is a diagram illustrating a ridehail application and ridehail service in communication with a central computer, according to some embodiments of the disclosure; and

FIG. 7 shows an example embodiment of a system for implementing certain aspects of the present technology.

### DETAILED DESCRIPTION

### Overview

Systems and methods are provided for determining an autonomous vehicle destination based on an image. In particular, systems and methods are provided for using an image-based input to determine a user’s pick-up location, drop-off location, stop location, or other destination location. In various implementations, the systems and methods disclosed herein eliminate the need for a user to explicitly input an address to hail a ride. Instead, when submitting a ride request, a user can input an image from a mobile device camera or from a mobile device photo library for one or both of the pick-up and drop-off fields, and the ridehail system can determine the location of the image(s) and thus the pick-up location and/or drop-off location. Additionally, a user can input an image for an intermediate stop location, and the ridehail system can determine the location of the image and thus the stop location. The ridehail system uses the pick-up location and/or drop-off location to determine the destination of an assigned autonomous vehicle.

In some instances, users do not know enough about their intended pick-up location and drop-off location to be able to input a name, address, or find the location on a map. Thus, in some scenarios, a user might not know enough about their pick-up location and/or drop-off location to successfully request a ride. In particular, in some situations, a user may not know their exact location. For example, during an emergency situation a user may not have time to localize themselves by inputting cross-streets. In another example, a visually impaired user may not be able to read street signs or building numbers to provide explicit location information. In some examples, a user may be in a foreign country where there is a language barrier or where a non-alphanumeric alphabet is used such that the user does not recognize the symbols in a name and is unable to replicate the symbols on a mobile device. In some examples, buildings within cities create canyons that prevent mobile device localization. In some examples, a user may have an image of a landmark but no information about what it is called or where it is located. In various examples, advanced mapping technology as well as image databases can be used to enable a location to be determined based on an input image.

According to some implementations, image-based destination determination can also be used in instances where an address spans a large area and can have multiple possible pick-up and/or drop-off locations that all fall within the address. In an example, if the user has specified an address of a stadium as a pick-up location, the address may include regions that are undesirable or inconvenient for user pick-up (e.g., an area of a road immediately adjacent to an occupied bus stop, an area of a road with a large puddle, an area of a road with a temporary barricade between the road and a sidewalk, an area of a road in a construction zone, etc.). Moreover, many vehicles share similar visual characteristics, and it may be difficult for the user to identify the autonomous vehicle assigned to provide the ride for the user from amongst a plurality of vehicles (including other autonomous vehicles) in an area surrounding the user. Using image-based destination determination, the user can upload an image of where they are waiting and the autonomous vehicle can drive to the user’s location.

Use of geocoding systems in determining a pick-up or drop-off location also has various drawbacks. For instance, a mobile computing device may transmit GPS coordinates indicative of a current position of a user of the mobile computing device as pick-up coordinates, but the user may not actually want the pick-up location to be at his or her current position. While certain pick-up systems may enable the user to specify a pick-up location other than his or her current location, these systems may lack precision and the autonomous vehicle may arrive at a position that was not intended by the user. Furthermore, geocoding systems often do not work in cities where tall buildings prevent clear signal transmission paths.

Additionally, while some images may include image location metadata, the image location metadata is determined using GPS coordinates or other geocoding systems of the device capturing the image, which can have the same inaccuracies as mentioned above. In particular, if a mobile device geocoding system is not functioning accurately, the image file location metadata will also be inaccurate, and thus not useful for determining location of the image. Furthermore, in some examples, an image can be captured from a distance such that the location of the device capturing the image is not the same as the location of the place pictured in the image. Additionally, in some examples, a mobile device can capture an image from a book, magazine, other printed material, or even from a billboard or screen, and in such cases the location of the device capturing the image (which may become image file location metadata) will be completely different from the location of the place pictured in the image.

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure are set forth in the proceeding in view of the drawings where applicable.

### Example Autonomous Vehicle Configured for Destination Determination

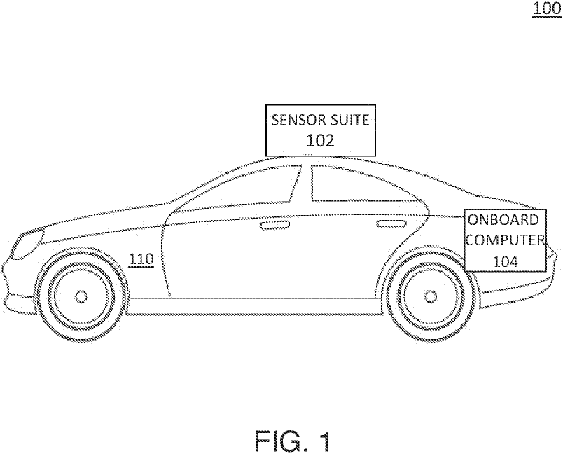

FIG. 1 is a diagram of an autonomous driving system 100 illustrating an autonomous vehicle 110, according to some embodiments of the disclosure. The autonomous vehicle 110 includes a sensor suite 102 and an onboard computer 104. In various implementations, the autonomous vehicle 110 uses sensor information from the sensor suite 102 to determine its location, to navigate traffic, to sense and avoid obstacles, and to sense its surroundings. According to various implementations, the autonomous vehicle 110 is part of a fleet of vehicles for picking up passengers and/or packages and driving to selected destinations. The autonomous vehicle 110 is configured for image-based pick-up location determination, drop-off location determination, and/or stop location determination. In some examples, a ride request transmitted to a ridehail application includes an image in place of an address, name, or mapped location for one of the pick-up location, drop-off location, and/or stop location, and the autonomous vehicle 110 can fulfill the ride request.

The sensor suite 102 includes localization and driving sensors. For example, the sensor suite may include one or more of photodetectors, cameras, radio detection and ranging (RADAR), SONAR, light detection and ranging (LIDAR), GPS, inertial measurement units (IMUs), accelerometers, microphones, strain gauges, pressure monitors, barometers, thermometers, altimeters, wheel speed sensors, and a computer vision system. The sensor suite 102 continuously monitors the autonomous vehicle’s environment. In some examples, data from the sensor suite 102 can provide localized traffic information. In some implementations, sensor suite 102 data includes image information that can be used to update an image database including location information for various images. In this way, sensor suite 102 data from many autonomous vehicles can continually provide feedback to the mapping system and the high fidelity map can be updated as more and more information is gathered.

In various examples, the sensor suite 102 includes cameras implemented using high-resolution imagers with fixed mounting and field of view. In further examples, the sensor suite 102 includes LIDARs implemented using scanning LIDARs. Scanning LIDARs have a dynamically configurable field of view that provides a point-cloud of the region intended to scan. In still further examples, the sensor suite 102 includes RADARs implemented using scanning RADARs with dynamically configurable field of view.

The autonomous vehicle 110 includes an onboard computer 104, which functions to control the autonomous vehicle 110. The onboard computer 104 processes sensed data from the sensor suite 102 and/or other sensors, in order to determine a state of the autonomous vehicle 110. In some implementations described herein, the autonomous vehicle 110 includes sensors inside the vehicle. In some examples, the autonomous vehicle 110 includes one or more cameras inside the vehicle. Based upon the vehicle state and programmed instructions, the onboard computer 104 controls and/or modifies driving behavior of the autonomous vehicle 110.

The onboard computer 104 functions to control the operations and functionality of the autonomous vehicle 110 and processes sensed data from the sensor suite 102 and/or other sensors in order to determine states of the autonomous vehicle. In some implementations, the onboard computer can execute a route to reach the destination identified using the systems and methods disclosed herein. In some implementations, the onboard computer 104 is a general-purpose computer adapted for I/O communication with vehicle control systems and sensor systems. In some implementations, the onboard computer 104 is any suitable computing device. In some implementations, the onboard computer 104 is connected to the Internet via a wireless connection (e.g., via a cellular data connection). In some examples, the onboard computer 104 is coupled to any number of wireless or wired communication systems. In some examples, the onboard computer 104 is coupled to one or more communication systems via a mesh network of devices, such as a mesh network formed by autonomous vehicles.

According to various implementations, the autonomous driving system 100 of FIG. 1 functions to enable an autonomous vehicle 110 to modify and/or set a driving behavior in response to parameters set by vehicle passengers (e.g., via a passenger interface). Driving behavior of an autonomous vehicle may be modified according to explicit input or feedback (e.g., a passenger specifying a maximum speed or a relative comfort level), implicit input or feedback (e.g., a passenger’s heart rate), or any other suitable data or manner of communicating driving behavior preferences.

The autonomous vehicle 110 is preferably a fully autonomous automobile, but may additionally or alternatively be any semi-autonomous or fully autonomous vehicle. In various examples, the autonomous vehicle 110 is a boat, an unmanned aerial vehicle, a driverless car, a golf cart, a truck, a van, a recreational vehicle, a train, a tram, a three-wheeled vehicle, or a scooter. Additionally, or alternatively, the autonomous vehicles may be vehicles that switch between a semi-autonomous state and a fully autonomous state and thus, some autonomous vehicles may have attributes of both a semi-autonomous vehicle and a fully autonomous vehicle depending on the state of the vehicle.

In various implementations, the autonomous vehicle 110 includes a throttle interface that controls an engine throttle, motor speed (e.g., rotational speed of electric motor), or any other movement-enabling mechanism. In various implementations, the autonomous vehicle 110 includes a brake interface that controls brakes of the autonomous vehicle 110 and controls any other movement-retarding mechanism of the autonomous vehicle 110. In various implementations, the autonomous vehicle 110 includes a steering interface that controls steering of the autonomous vehicle 110. In one example, the steering interface changes the angle of wheels of the autonomous vehicle. The autonomous vehicle 110 may additionally or alternatively include interfaces for control of any other vehicle functions, for example, windshield wipers, headlights, turn indicators, air conditioning, etc.

### Example Method for Determining Autonomous Vehicle Destination

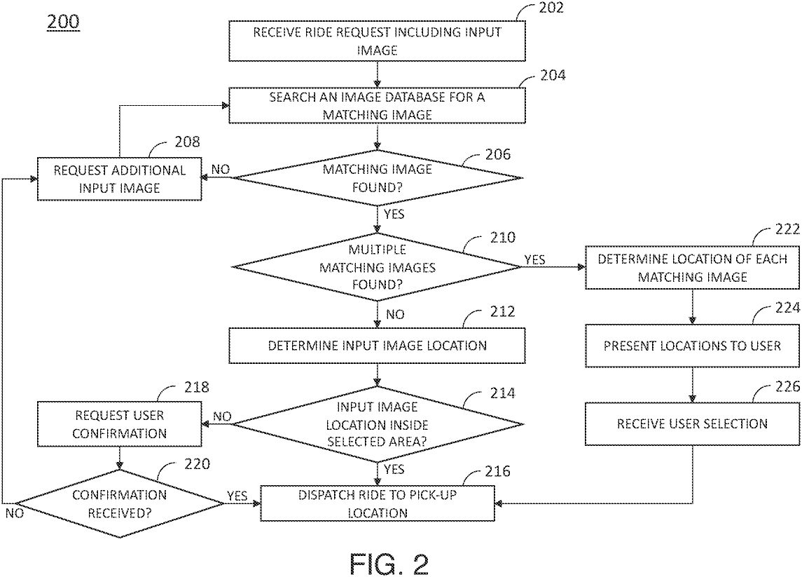

FIG. 2 is a flowchart illustrating a method 200 for a ridehail service to determine an autonomous vehicle destination, according to some embodiments of the disclosure. In particular, the method 200 can be used to determine a ride request pick-up location, which is an autonomous vehicle destination for passenger pick-up, and the method 200 can be used to determine a ride request drop-off location, which is an autonomous vehicle destination for passenger drop-off. Additionally, the method 200 can be used to determine a ride request stop location, which is an autonomous vehicle destination for a passenger intermediate stop during a ride. In further examples, the method 200 can be used to determine a delivery request pick-up location and/or drop-off location for a package. In various implementations, the steps in the method 200 can be performed in a different order than depicted in the flowchart. In some implementations, one or more of the steps in the method 200 can be performed partially or completely in parallel with other steps in the method 200.

At step 202, a ride request is received including an input image. In particular, for at least one of the pick-up location, the drop-off location, and an intermediate stop location, an image is received instead of an address or location. In various examples, the image can be a photo of a building, an apartment complex, a house, a doorway, a coffee shop, a café, a restaurant, a store, a number on a building, a sign, or a landmark. In various examples, a ride request can include more than one input image. For example, a ride request that includes an input image in place of an address for a pick-up location can include more than one input image of the pick-up location. In some examples, a ride request includes one or more input images in place of an address for a pick-up location and one or more input images in place of an address for a drop-off location. In various examples, the input image can be a 2D image, a 3D image, an RGB image, a LIDAR scan of an area, a video, a screenshot from a browser, a time-of-flight image, or a picture from a book, magazine, newspaper, or other printed material.

At step 204, an image database is searched for an image matching the received image from the ride request. In particular, the image database is searched for an image of the same thing as the received image, such that while both images are photos of the same thing, the two images themselves do not match. In one example, the received input image is a photo of a store front, and the matching image from the database is a different photo of the same store front.

At step 206, it is determined whether a matching image is found in the image database. In various examples, the image database can include images captured by autonomous vehicles in an autonomous vehicle fleet while the vehicles drive around in an operational city. If no matching image is found at step 206, the method 200 proceeds to step 208 and an additional input image is requested. In various examples, the ridehail application through which the ride request was received can transmit a request for another image. In some examples, the image database continues to be searched for matching images while the method 200 proceeds to step 208. After an additional image is received, the method 200 returns to step 204 and searches the image database again for a matching image.

At step 206, if a matching image is found, the method 200 proceeds to step 210. At step 210, it is determined whether one matching image was found in the image database or whether multiple matching images were found in the image database. If only one matching image was found, the method 200 proceeds to step 212 and determines the input image location based on the known location of the matching image. At step 214, it is determined whether the identified input image location is inside a selected area, for example a geofenced area. If the identified input image location is inside the selected area, the method 200 proceeds to step 216 and an autonomous vehicle is dispatched to the identified location. In particular, if the input image is a pick-up location, an autonomous vehicle is dispatched to the pick-up location. If the input image is a drop-off location, the route corresponding to the ride request will be generated for the identified drop-off location. Similarly, if the input image is an intermediate stop location, the route corresponding to the ride request will be generated to include the intermediate stop location. In some examples, if the input image is a drop-off location, an autonomous vehicle may have already been dispatched to the pick-up location before the drop-off location is determined.

If, at step 214, the identified input image location at step 212 is outside the selected area, the identified location may be far away. Thus, at step 214, if the identified location is not inside the selected area, the method 200 proceeds to step 218 and requests user confirmation of the identified location. In some examples, user confirmation is requested through the ridehail application from which the ride request was received. At step 220, it is determined whether user confirmation of the identified input image location is received. If user confirmation is received at step 220, the method 200 proceeds to step 216 and an autonomous vehicle is dispatched to the pick-up location. In particular, if the input image is a pick-up location, an autonomous vehicle is dispatched to the pick-up location. If the input image is a drop-off location, the route corresponding to the ride request will be generated for the identified drop-off location, as described above. At step 220, if user confirmation is not received, or if the user indicates the identified location is incorrect, the method returns to step 208 and requests an additional input image.

At step 210, if multiple images are found in the image database that match the input image, the method 200 proceeds to step 222, and the location of each matching image is determined. Note that if there are multiple images of the same place, the images can be batched together such that the images are all associated with the same location. For example, if multiple images are slightly different images of the same location (e.g., if the location of one image is within a select distance of the location of another image), the images can be batched together. Thus, in various examples, at step 210, multiple images refers to multiple batches of images, where each batch of images has a single unique location. Thus, if multiple images and/or batches of images are found at step 210, each with a unique location, the method proceeds to step 224.

At step 224, the multiple locations are presented to the user via the ridehail application through which the ride request was received, and the ridehail application allows the user to select one of the identified locations. At step 226, the user location selection is received. The method 200 proceeds to step 216 and an autonomous vehicle is dispatched to the pick-up location. In some examples, if multiple matching images are found at step 210, the method 200 can proceed to step 208 and request an additional input image which can help narrow the set of matching images.

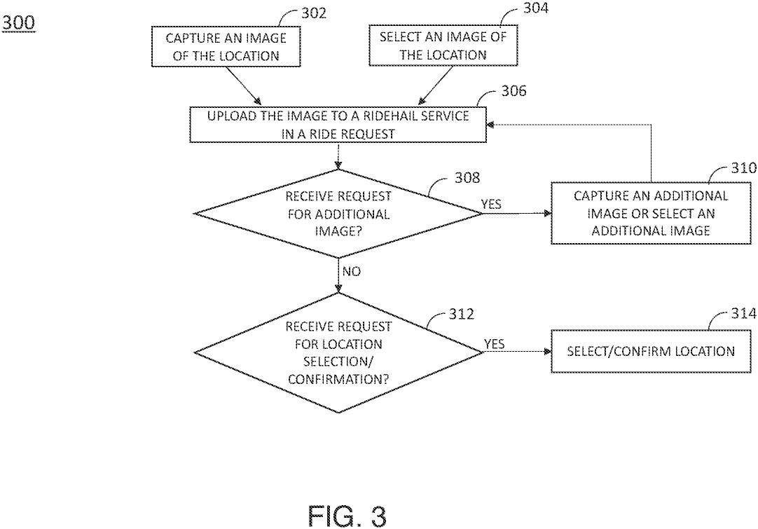

FIG. 3 is a diagram illustrating a method 300 for a user to request a ride using an input image for a location via a ridehail application, according to some embodiments of the disclosure. When requesting a ride through a ridehail application, a user can elect to start the method 300 either at step 302 or step 304, and, instead of entering an address or name of a location for the pick-up and/or drop-off location, the user can enter an image of a location. In some examples, instead of entering a pick-up location, a user can take a picture of their current location. In particular, at step 302, the user can use a mobile device to capture an image of their location and submit the image as the pick-up location. In some examples, the ridehail application on the mobile device can include an option for accessing the camera and capturing an image of the pick-up location.

Alternatively, at step 304, the user can select an image of the pick-up location. In some examples, a user can select an image from a photo library on the user’s phone. The image can be an image the user captured or it can be another image, such as an image the user downloaded or received. The image selected at step 304 can be an image of the pick-up location or the image selected at step 304can be an image of the drop-off location. In some examples, the ridehail application on the mobile device can include an option for accessing the mobile device photo library and the user can select one or more images from the photo library for the pick-up and/or drop-off location.

At step 306, a ride request including the image(s) from step 302 and/or step 304 is uploaded from the ridehail application on the mobile device to a ridehail service. In various examples, the ridehail service is configured to receive the uploaded image and search for a match for the uploaded image in an image database. In various examples, a match for the uploaded image includes an image of the same location; the image itself may be different but it is a photo of the same location. Each image in the image database includes a corresponding address. Thus, if a matching image is found, the corresponding address of the matching image can be used for the location. For example, if an image is uploaded for the pick-up location and a matching image is found in the image database, the corresponding address for the matching image is used as the pick-up location. Similarly, if an image is uploaded for the drop-off location and a matching image is found in the image database, the corresponding address for the matching image is used as the drop-off location.

If the ridehail service is unable to find a matching image, the mobile device may display a prompt for additional images. If, at step 308, a request for additional images is received at the mobile device, the method proceeds to step 310. At step 310, the user can submit another image of a location. In some examples, the user can take another picture of their current location and/or the user can select an image of the pick-up and/or drop-off location. From step 310, the method 300 returns to step 306 and the input image is uploaded.

If no request for additional images is received at step 308, the method 300 proceeds to step 312. In some examples, if the ridehail service identifies multiple matching images, the ridehail service may present multiple corresponding locations via the ridehail application on the mobile device, allowing the user to select one of the corresponding locations. In particular, at step 312, if a request for location selection is received, the method 300 proceeds to step 314. At step 314, the user can select one of multiple locations. In some examples, the ridehail service identifies a single matching location but the matching location is outside a geofenced area that encompasses a typical service operation area, and thus the ridehail service requests confirmation of the identified location. Thus, at step 312, if a request for location confirmation is received, the method 300 proceeds to step 314. At step 314, the user can confirm (or reject) the identified location.

In some examples, after an image is uploaded to the ridehail service, a matching image is identified, the image location is determined, and the ride request is entered without any additional input or confirmation from the user. In general, the ride request service with input images is automated to minimize further user interaction, and additional input (images, confirmation, location selection) is only requested when necessary. Thus, from a user perspective, the method 300 may end at step 306.

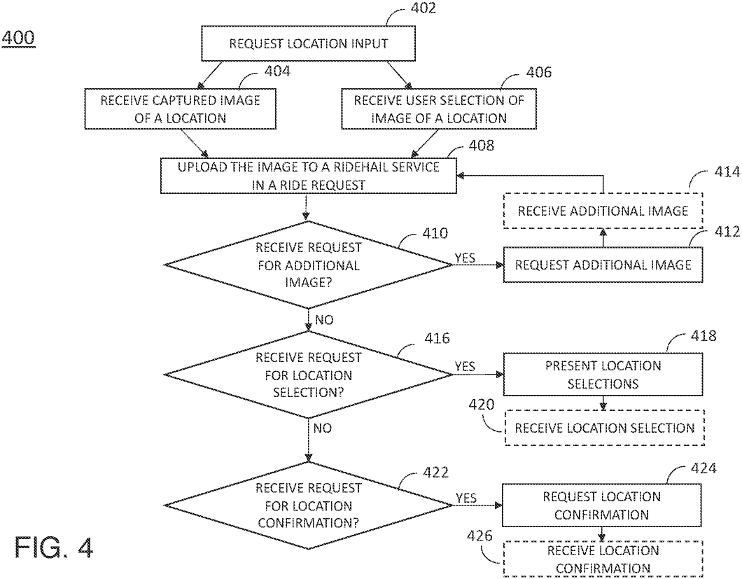

FIG. 4 is a flow chart illustrating a method 400 for a ridehail application to receive and transmit a ride request including an input image for a pick-up and/or drop-off location, according to some embodiments of the disclosure. At step 402, the ridehail application requests location input. In particular, in a mobile device ridehail application, when entering a ride request, a user is prompted to submit a pick-up location and a drop-off location. For the pick-up location, the ridehail application presents the option of accessing the mobile device camera to capture a photo of a user’s current location. Additionally, for both the pick-up location and the drop-off location, the ridehail application presents the option of selecting an image in place of entering an address or location name.

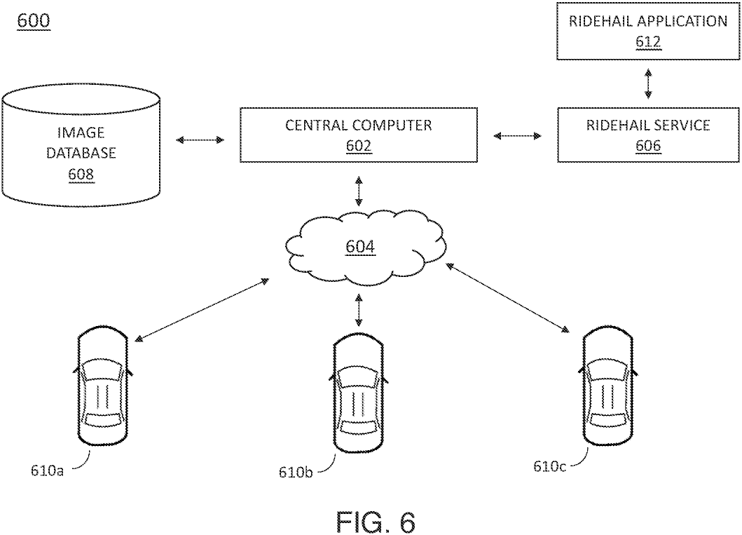

Following step 402, the method 400 proceeds to one (or both) of steps 404 and 406. At step 404, a captured image of a location from the mobile device camera is received at the ridehail application. At step 406, an image of a location from a photo library is received at the ridehail application. At step 408, a ride request including the image is uploaded from the ridehail application on the mobile device to a ridehail service. In some examples, the ridehail service is a cloud-based ridehail service, and the ride request and input image(s) are uploaded to the cloud. In some examples, the ridehail service is in communication with a central computing system as described below with respect to FIG. 6.

Once the ridehail application has uploaded the ride request including any images, the ridehail application can, in some examples, receive confirmation of the ride request. However, in some examples, the ridehail application receives a request for additional information. For example, if the ridehail service is unable to find an image in the image database that matches the input image, the ridehail service may request an additional image. Thus, at step 410, if the ridehail application receives a request for an additional image, the method 400 proceeds to step 412 and the ridehail application on the mobile device displays a request for an additional image. If an additional image is received at step 414, the method 400 returns to step 408 and the ridehail application uploads the additional image to the ridehail service.

If no request for an additional image is received at step 410, the method 400 proceeds to step 416. In some examples, if the ridehail service identifies multiple images in the image database that match the input image, at step 416, the ridehail service may transmit the multiple locations corresponding to the matching images to the ridehail application, and request that one of the locations be selected. Thus, at step 416, if the ridehail application receives a request for location selection, the method 400 proceeds to step 418 and the ridehail application on the mobile device displays the multiple location selections. If a location selection is received at step 420, the ridehail application transmits the location selection to the ridehail service and the ride request is entered.

If, at step 416, there is no request for location selection, the method 400 proceeds to step 422. In some examples, the ridehail service identifies an image in the image database that matches the input image, but the corresponding location for the image is outside a selected geofenced area. The geofenced area may be the typical area of operation for the ridehail service. At step 422, the ridehail service may request confirmation of the identified location given that it is outside the typical area of operation for the ridehail service. At step 422, if the ridehail application receives a request for location identification confirmation, the method 400 proceeds to step 424 and the ridehail application on the mobile device displays a request for location confirmation. If a location confirmation is received at step 426, the ridehail application transmits the location confirmation to the ridehail service and the ride request is entered. In various examples, if no request for location confirmation is received at step 422, the method 400 ends, and the identified location is automatically entered as the destination location for the associated pick-up, drop-off, or stop location.

### Example of an Image-Based Location Determination Interface

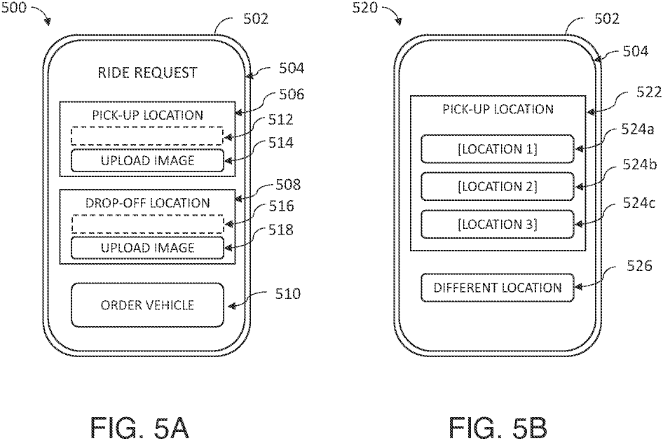

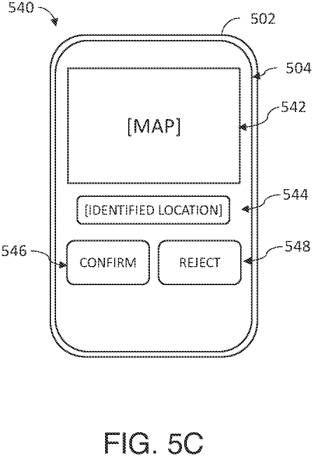

FIGS. 5A-5C show examples 500, 520, 540 of an interface for a ridehail service for a ride request with image-based location determination, according to some embodiments of the disclosure. FIG. 5A is an example 500 of a device 502 showing a ride request interface 504 for a ridehail application. In particular, the ride request interface 504 on a mobile device includes a pick-up location entry portion 506 and a drop-off location entry portion 508. The pick-up location entry portion 506 provides the option to enter an address or location using a mobile device keyboard in the box 512, as well as the option to upload an image using the button 514. In some examples, if the “upload image” button 514 is selected, the ridehail application presents the option to access the camera to take a photo or to access the photo library to select an image.

The drop-off location entry portion 508 provides the option to enter an address or location using a mobile device keyboard in the box 516, as well as the option to upload an image using the button 518. In some examples, if the “upload image” button 518 is selected, the user is presented with the option to access the photo library to select an image. In some examples, if the “upload image” button 518 is selected, the user is presented with the option to access the camera to take a photo of the drop-off location. In one example, a user may access the camera to take a photo of the drop-off location when the drop-off location is a large landmark that the user can see but which is far away.

In various examples, the “order vehicle” button 510 becomes enabled when a pick-up location entry 506 has been entered and a drop-off location entry 508 has been entered or uploaded, where an entry can include an image. When the “order vehicle” button 510 is selected, the ride request is submitted from the ridehail application on the mobile device to the ridehail service in the cloud.

FIG. 5B shows an example 520 of a ridehail application interface that may be displayed if the ridehail service identifies more than one matching image in the image database for the input image. In particular, FIG. 5B shows the ridehail application interface presenting three potential pick-up locations with first 524a, second 524b, and third 524c buttons. In various examples, the rideshare service returned the three locations to the ridehail application. In some examples, each of the first 524a, second 524b, and third 524c buttons is labeled with a location and/or address. The user can select the button 524a, 524b, 524c corresponding to the user’s pick-up location. The ridehail application interface 520 also includes a “different location” button 526, which can be selected if none of the location options on the first 524a, second 524b, and third 524c buttons indicate the correct pick-up location.

FIG. 5C shows an example 540 of a ridehail application interface that may be displayed if the ridehail service identifies a matching image in the image database with a corresponding location that is outside a selected area. For example, if the location of the matching image is outside a geofenced area the ridehail application interface can display the interface shown in the example 540. In various examples, the geofenced area can be a general area of operation for the ridehail service. In various examples, while the ridehail service can operate outside the geofenced area, the service may request confirmation that the identified location is accurate before dispatching an autonomous vehicle to a location outside the geofenced area.

When a ridehail application requests user confirmation of an identified location, the ridehail application can display the address and/or name of the identified location in the box 544 as well as a map 542 labeling the identified location. The ridehail application can provide the user an option to confirm the identified location with the button 546. Selection of the “confirm” button 546 may cause the ridehail application to transmit the confirmation of the identified location to the ridehail service, and the ridehail service may then dispatch an autonomous vehicle to the location, as described above with respect to FIGS. 2-4. The ridehail application can provide the user an option to reject the identified location with the button 548. Selection of the “reject” button 548 may cause the ridehail application to transmit the rejection of the identified location to the ridehail service. The ridehail service may then continue to search for a matching image in the image database and, in some examples, the ridehail service may transmit a request to the ridehail application for an additional image of the location.

### Example Ridehail System With Image Database

FIG. 6 is a diagram 600 illustrating a ridehail application 612 and ridehail service 606 in communication with a central computer 602, according to some embodiments of the disclosure. The central computer 602 can access an image database 608 that contains images along with corresponding locations. In various implementations, a ridehail application 612 transmits a ride request to the ridehail service 606. The ridehail application 612 can implement the method 400 of FIG. 4. In some examples, the ride request pick-up location includes one or more input images. Similarly, in some examples, the ride request drop-off location includes one or more input images. The ridehail service 606 can be a cloud-based ridehail service. The ridehail service 606 sends the ride request to the central computer 602, which searches the image database 608 for one or more images that match input images. When a matching image in the image database 608 is identified, the corresponding location of the matching image is used for the ride request pick-up and/or drop-off location.

In some examples, the central computer 602 includes a routing coordinator and a database of information. The central computer 602 can also act as a centralized ride management system and communicates with ridehail users via a ridehail service 606 and user ridehail applications 612. In various examples, the central computer 602 can implement an input image-based pick-up location and/or drop-off location determination. The central computer 602 can implement the method 200 of FIG. 2. In various implementations, the central computer 602 can send ride and/or routing instructions to autonomous vehicles 610a-610c in a fleet of autonomous vehicles, as described below.

In some examples, the image database 608 includes images captured by autonomous vehicles in an autonomous vehicle fleet. In some examples, autonomous vehicles regularly capture high definition images and LIDAR data of the environments in which the vehicles drive. The high definition images and LIDAR data can be saved in an image database 608, providing a comprehensive, labeled, searchable, efficient database. Furthermore, the images and LIDAR data can each be saved with corresponding location in a hyper high definition map.

The image database 608 can include historical and real-time aggregated autonomous vehicle sensor data. In addition to images from mapping data, the image database 608 can include images from many thousands of hours of image data captured from autonomous vehicles in an autonomous vehicle fleet operating on roads. The on-road autonomous vehicle images can provide both historical and real-time image data. In some examples, the image search completed by the central computer 602 relies on machine learning. In some examples, image search uses image search features. The vast amount of image data from many autonomous vehicles over time increases the likelihood of a location being captured in many possible environments (e.g., different weather conditions, different times of day, different lighting, partial occlusion). Additionally, the large amount of image data from many autonomous vehicles overtime increases the likelihood of a location being captured from multiple different angles. In one example, if an image shows a partially occluded outdoor sculpture (e.g., people in front of the sculpture) at nighttime in the winter, but it is currently 2pm on a clear summer day, years of data can still be searched in the image database 608, maximizing the likelihood of finding a match. Furthermore, as users begin using the input image feature, a secondary database of user-provided images can be built to continue to train the image search models. Additionally, user-uploaded images may access angles that the autonomous vehicles cannot reach due to the constrained vantage point of autonomous vehicles (i.e., the vantage point from the road).

As shown in FIG. 6, the vehicles 610a-610c communicate wirelessly with a cloud 604 and the central computer 602. The central computer 602 includes a routing coordinator and a database of information from the vehicles 610a-610c in the fleet. In some implementations, the autonomous vehicles 610a-610c communicate directly with each other.

When a ride request is received from a ridehail application 612 at a ridehail service 606, the ridehail service 606 sends the request to central computer 602. In some examples, when a ride request is received by the central computer 602, the vehicle 610a-610c to fulfill the request is selected and a route for the vehicle 610a-610c is generated by the routing coordinator. In other examples, the routing coordinator provides the vehicle 610a-610c with a set of parameters and the vehicle 610a-610c generates an individualized specific route. The generated route includes a route from the autonomous vehicle’s 610a-610c present location to the pick-up location, and a route from the pick-up location to the drop-off location. In some examples, each of the autonomous vehicles 610a-610c in the fleet is equipped to capture images while driving and captured images along with corresponding image locations can be saved to the image database 608. The vehicles 610a-610c communicate with a central computer 602 via a cloud 604.

Once a destination is selected and the user has ordered a vehicle, the routing coordinator can optimize the routes to avoid traffic as well as vehicle occupancy. In some examples, an additional passenger can be picked up en route to the destination, and the additional passenger can have a different destination. In various implementations, since the routing coordinator has information on the assigned routes for all the vehicles in the fleet, the routing coordinator can adjust vehicle routes to reduce congestion and increase vehicle occupancy.

As described above, each vehicle 610a-610c in the fleet of vehicles communicates with a routing coordinator. Thus, information gathered by various autonomous vehicles 610a-610c in the fleet can be saved and used to generate information for future routing determinations. For example, sensor data can be used to generate route determination parameters. In general, the information collected from the vehicles in the fleet can be used for route generation or to modify existing routes. Additionally, images captured by autonomous vehicle 610a-610c sensor suites or other cameras can be tagged with a location and saved to the image database 608. In some examples, the routing coordinator collects and processes position data from multiple autonomous vehicles in real-time to avoid traffic and generate a fastest-time route for each autonomous vehicle. In some implementations, the routing coordinator uses collected position data to generate a best route for an autonomous vehicle in view of one or more traveling preferences and/or routing goals. In some examples, the routing coordinator uses collected position data corresponding to emergency events to generate a best route for an autonomous vehicle to avoid a potential emergency situation.

According to various implementations, a set of parameters can be established that determine which metrics are considered (and to what extent) in determining routes or route modifications from a pick-up location to a drop-off location. For example, expected congestion or traffic based on a known event can be considered. Generally, a routing goal refers to, but is not limited to, one or more desired attributes of a routing plan indicated by at least one of an administrator of a routing server and a user of the autonomous vehicle. The desired attributes may relate to a desired duration of a route plan, a comfort level of the route plan, a vehicle type for a route plan, and the like. For example, a routing goal may include time of an individual trip for an individual autonomous vehicle to be minimized, subject to other constraints. As another example, a routing goal may be that comfort of an individual trip for an autonomous vehicle be enhanced or maximized, subject to other constraints.

Routing goals may be specific or general in terms of both the vehicles they are applied to and over what timeframe they are applied. As an example of routing goal specificity in vehicles, a routing goal may apply only to a specific vehicle, or to all vehicles in a specific region, or to all vehicles of a specific type, etc. Routing goal timeframe may affect both when the goal is applied (e.g., some goals may be ‘active’ only during set times) and how the goal is evaluated (e.g., for a longer-term goal, it may be acceptable to make some decisions that do not optimize for the goal in the short term, but may aid the goal in the long term). Likewise, routing vehicle specificity may also affect how the goal is evaluated; e.g., decisions not optimizing for a goal may be acceptable for some vehicles if the decisions aid optimization of the goal across an entire fleet of vehicles. In some examples, a routing goal may include a slight detour to drive on a rarely-used street to capture images for the image database 608.

Some examples of routing goals include goals involving trip duration (either per trip, or average trip duration across some set of vehicles and/or times), physics, and/or company policies (e.g., adjusting routes chosen by users that end in lakes or the middle of intersections, refusing to take routes on highways, etc.), distance, velocity (e.g., max., min., average), source/destination (e.g., it may be optimal for vehicles to start/end up in a certain place such as in a pre-approved parking space or charging station), intended arrival time (e.g., when a user wants to arrive at a destination), duty cycle (e.g., how often a car is on an active trip vs. idle), energy consumption (e.g., gasoline or electrical energy), maintenance cost (e.g., estimated wear and tear), money earned (e.g., for vehicles used for ridesharing), person-distance (e.g., the number of people moved multiplied by the distance moved), occupancy percentage, higher confidence of arrival time, user-defined routes or waypoints, fuel status (e.g., how charged a battery is, how much gas is in the tank), passenger satisfaction (e.g., meeting goals set by or set for a passenger) or comfort goals, environmental impact, toll cost, etc. In examples where vehicle demand is important, routing goals may include attempting to address or meet vehicle demand.

Routing goals may be combined in any manner to form composite routing goals; for example, a composite routing goal may attempt to optimize a performance metric that takes as input trip duration, rideshare revenue, and energy usage, and also, optimize a comfort metric. The components or inputs of a composite routing goal may be weighted differently and based on one or more routing coordinator directives and/or passenger preferences.

The routing coordinator uses maps to select an autonomous vehicle from the fleet to fulfill a ride request. In some implementations, the routing coordinator sends the selected autonomous vehicle the ride request details, including pick-up location and drop-off location, and an onboard computer on the selected autonomous vehicle generates a route and navigates to the destination. In some implementations, the routing coordinator in the central computer 602 generates a route for each selected autonomous vehicle 610a-610c, and the routing coordinator determines a route for the autonomous vehicle 610a-610c to travel from the autonomous vehicle’s current location to a first destination.

### Example of a Computing System for Ride Requests

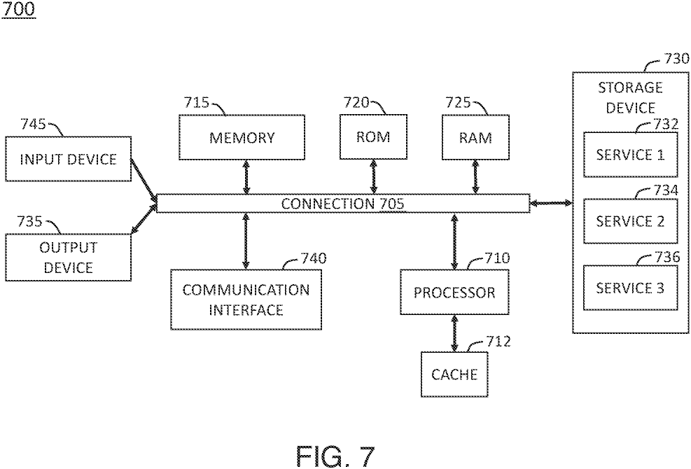

FIG. 7 shows an example embodiment of a computing system 700 for implementing certain aspects of the present technology. In various examples, the computing system 700 can be any computing device making up the onboard computer 104, the central computer 602, or any other computing system described herein. The computing system 700 can include any component of a computing system described herein which the components of the system are in communication with each other using connection 705. The connection 705 can be a physical connection via a bus, or a direct connection into processor 710, such as in a chipset architecture. The connection 705 can also be a virtual connection, networked connection, or logical connection.

In some implementations, the computing system 700 is a distributed system in which the functions described in this disclosure can be distributed within a datacenter, multiple data centers, a peer network, etc. In some embodiments, one or more of the described system components represents many such components each performing some or all of the functions for which the component is described. In some embodiments, the components can be physical or virtual devices.

The example system 700 includes at least one processing unit, e.g., a central processing unit (CPU), or a processor, 710 and a connection 705 that couples various system components including system memory 715, such as read-only memory (ROM) 720 and random access memory (RAM) 725 to processor 710. The computing system 700 can include a cache of high-speed memory 712 connected directly with, in close proximity to, or integrated as part of the processor 710.

The processor 710 can include any general-purpose processor and a hardware service or software service, such as services 732, 734, and 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction, the computing system 700 includes an input device 745, which can represent any number of input mechanisms, such as a microphone for speech, a touch-sensitive screen for gesture or graphical input, keyboard, mouse, motion input, speech, etc. The computing system 700 can also include an output device 735, which can be one or more of a number of output mechanisms known to those of skill in the art. In some instances, multimodal systems can enable a user to provide multiple types of input/output to communicate with the computing system 700. The computing system 700 can include a communications interface 740, which can generally govern and manage the user input and system output. There is no restriction on operating on any particular hardware arrangement, and therefore the basic features here may easily be substituted for improved hardware or firmware arrangements as they are developed.

A storage device 730 can be a non-volatile memory device and can be a hard disk or other types of computer-readable media which can store data that are accessible by a computer, such as magnetic cassettes, flash memory cards, solid state memory devices, digital versatile disks, cartridges, RAMs, ROM, and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as a processor 710, a connection 705, an output device 735, etc., to carry out the function.

As discussed above, each vehicle in a fleet of vehicles communicates with a routing coordinator. When a vehicle is flagged for service, the routing coordinator schedules the vehicle for service and routes the vehicle to the service center. When the vehicle is flagged for maintenance, a level of importance or immediacy of the service can be included. As such, service with a low level of immediacy will be scheduled at a convenient time for the vehicle and for the fleet of vehicles to minimize vehicle downtime and to minimize the number of vehicles removed from service at any given time. In some examples, the service is performed as part of a regularly-scheduled service. Service with a high level of immediacy may require removing vehicles from service despite an active need for the vehicles.

Routing goals may be specific or general in terms of both the vehicles they are applied to and over what timeframe they are applied. As an example of routing goal specificity in vehicles, a routing goal may apply only to a specific vehicle, or to all vehicles of a specific type, etc. Routing goal timeframe may affect both when the goal is applied (e.g., urgency of the goal, or, some goals may be ‘active’ only during set times) and how the goal is evaluated (e.g., for a longer-term goal, it may be acceptable to make some decisions that do not optimize for the goal in the short term, but may aid the goal in the long term). Likewise, routing vehicle specificity may also affect how the goal is evaluated; e.g., decisions not optimizing for a goal may be acceptable for some vehicles if the decisions aid optimization of the goal across an entire fleet of vehicles.

In various implementations, the routing coordinator is a remote server or a distributed computing system connected to the autonomous vehicles via an Internet connection. In some implementations, the routing coordinator is any suitable computing system. In some examples, the routing coordinator is a collection of autonomous vehicle computers working as a distributed system.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

### Select Examples

Example 1 provides a method for determining vehicle destination, comprising: receiving a ride request including an input image, wherein the input image corresponds to one of a pick-up location, a stop location, and a drop-off location; searching an image database for an entry matching the input image; identifying the entry matching the input image, wherein the entry includes a corresponding location; and determining an input image location based on the corresponding location.

Example 2 provides a method according to one or more of the preceding and/or following examples, wherein identifying the image entry matching the input image comprises: identifying a plurality of image entries matching the input image and a corresponding plurality of entry locations, wherein each of the plurality of image entries includes a respective entry location from the corresponding plurality of entry locations, and further comprising transmitting the plurality of entry locations to a ridehail application.

Example 3 provides a method according to one or more of the preceding and/or following examples, further comprising receiving a first selection from the plurality of entry locations, wherein the first selection is the input image location.

Example 4 provides a method according to one or more of the preceding and/or following examples, further comprising requesting an additional input image.

Example 5 provides a method according to one or more of the preceding and/or following examples, further comprising transmitting a request for confirmation of the input image location to a ridehail application.

Example 6 provides a method according to one or more of the preceding and/or following examples, further comprising dispatching an autonomous vehicle to a ride request pick-up location.

Example 7 provides a method according to one or more of the preceding and/or following examples, wherein receiving a ride request comprises receiving a package delivery request.

Example 8 provides a system for determining vehicle destination, comprising: an online portal configured to receive a ride request including an input image, wherein the input image corresponds to one of a pick-up location, a stop location, and a drop-off location; an image database including image entries with corresponding locations; and a central computer configured to receive the ride request, search the image database for a first image entry matching the input image, identify the first image entry and first corresponding location, and determine an input image location based on the first corresponding location.

Example 9 provides a system according to one or more of the preceding and/or following examples, wherein the central computer is further configured to: identify a first plurality of image entries matching the input image and a corresponding first plurality of entry locations, wherein each of the first plurality of image entries includes a respective entry location from the corresponding first plurality of entry locations, and transmit the first plurality of entry locations to the online portal.

Example 10 provides a system according to one or more of the preceding and/or following examples, wherein the online portal is further configured to receive a first selection from the first plurality of entry locations, wherein the first selection is the input image location.

Example 11 provides a system according to one or more of the preceding and/or following examples, wherein the central computer is further configured to request an additional input image via the online portal.

Example 12 provides a system according to one or more of the preceding and/or following examples, wherein the central computer is further configured to request confirmation of the input image location via the online portal.

Example 13 provides a system according to one or more of the preceding and/or following examples, wherein the central computer is further configured to dispatch an autonomous vehicle to the pick-up location.

Example 14 provides a system according to one or more of the preceding and/or following examples, wherein the ride request comprises a package delivery request.

Example 15 provides a system according to one or more of the preceding and/or following examples, further comprising an autonomous vehicle configured to capture a plurality of photos while driving and transmit the photos to the central computer, wherein each of the plurality of photos is entered into the image database.

Example 16 provides a system for determining vehicle destinations in an autonomous vehicle fleet, comprising: a plurality of autonomous vehicles, each configured to capture a plurality of photos with corresponding photo locations; an image database configured to store each of the plurality of photos and corresponding photo locations as image entries; and a central computer configured to: receive a ride request including an input image, wherein the input image corresponds to one of a pick-up location, a stop location, and a drop-off location; search the image database for a first image entry matching the input image; and identify the first image entry and a first corresponding location, and determine an input image location based on the first corresponding location.

Example 17 provides a system according to one or more of the preceding and/or following examples, wherein the image database is further configured to store the input image and the input image location.

Example 18 provides a system according to one or more of the preceding and/or following examples, wherein the central computer is further configured to route a first autonomous vehicle from the plurality of autonomous vehicles to the input image location.

Example 19 provides a system according to one or more of the preceding and/or following examples, wherein the central computer receives the ride request from a ridehail application, and wherein the central computer is further configured to transmit a request for an additional input image to the ridehail application.

Example 20 provides a system according to one or more of the preceding and/or following examples, wherein the central computer receives the ride request from a ridehail application, and wherein the central computer is further configured to request confirmation of the input image location via the ridehail application.

Example 21 provides a system according to one or more of the preceding and/or following examples, wherein the online portal is a ridehail application on a mobile device.

Example 22 provides a method according to one or more of the preceding and/or following examples, wherein the input image is submitted in place of an address for one of the pick-up location, the stop location, and the drop-off location;

Example 23 provides a method for determining vehicle destination, comprising: receiving a ride request including an input image, wherein the input image is submitted in place of an address for one of a pick-up location, a stop location, and a drop-off location; searching an image database for an entry matching the input image; identifying the entry matching the input image, wherein the entry includes a corresponding location; and determining an input image location based on the corresponding location.

### Variations and Implementations

As will be appreciated by one skilled in the art, aspects of the present disclosure, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g. one or more microprocessors, or one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g. to the existing perception system devices and/or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The preceding disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting.

Other features and advantages of the disclosure will be apparent from the description and the claims. Note that all optional features of the apparatus described above may also be implemented with respect to the method or process described herein and specifics in the examples may be used anywhere in one or more embodiments.

The ‘means for’ in these instances (above) can include (but is not limited to) using any suitable component discussed herein, along with any suitable software, circuitry, hub, computer code, logic, algorithms, hardware, controller, interface, link, bus, communication pathway, etc. In a second example, the system includes memory that further comprises machine-readable instructions that when executed cause the system to perform any of the activities discussed above.

What is claimed is:

1. A method for determining vehicle destination, comprising:
receiving a ride request including an input image, wherein the input image corresponds to one of a pick-up location, a stop location, and a drop-off location;
searching an image database for an image entry matching the input image;
identifying the image entry matching the input image, wherein the image entry includes a corresponding location; and
determining an input image location based on the corresponding location.

2. The method of claim 1, wherein identifying the image entry matching the input image comprises:
identifying a plurality of image entries matching the input image and a corresponding plurality of entry locations, wherein each of the plurality of image entries includes a respective entry location from the corresponding plurality of entry locations, and
further comprising transmitting the plurality of entry locations to a ridehail application.

3. The method of claim 2, further comprising receiving a first selection from the plurality of entry locations, wherein the first selection is the input image location.

4. The method of claim 1, further comprising requesting an additional input image.

5. The method of claim 1, further comprising transmitting a request for confirmation of the input image location to a ridehail application.

6. The method of claim 1, further comprising dispatching an autonomous vehicle to a ride request pick-up location.

7. The method of claim 1, wherein receiving a ride request comprises receiving a package delivery request.

8. A system for determining vehicle destination, comprising:
an online portal configured to receive a ride request including an input image, wherein the input image corresponds to one of a pick-up location, a stop location, and a drop-off location;
an image database including image entries with corresponding locations; and
a central computer configured to receive the ride request, search the image database for a first image entry matching the input image, identify the first image entry and first corresponding location, and determine an input image location based on the first corresponding location.

9. The system of claim 8, wherein the central computer is further configured to:
identify a first plurality of image entries matching the input image and a corresponding first plurality of entry locations, wherein each of the first plurality of image entries includes a respective entry location from the corresponding first plurality of entry locations, and
transmit the first plurality of entry locations to the online portal.

10. The system of claim 9, wherein the online portal is further configured to receive a first selection from the first plurality of entry locations, wherein the first selection is the input image location.

11. The system of claim 8, wherein the central computer is further configured to request an additional input image via the online portal.

12. The system of claim 8, wherein the central computer is further configured to request confirmation of the input image location via the online portal.

13. The system of claim 8, wherein the central computer is further configured to dispatch an autonomous vehicle to the pick-up location.

14. The system of claim 8, further comprising an autonomous vehicle configured to capture a plurality of photos while driving and transmit the photos to the central computer, wherein each of the plurality of photos is entered into the image database.

15. The system of claim 8, wherein the ride request comprises a package delivery request.

16. A system for determining vehicle destinations in an autonomous vehicle fleet, comprising:
a plurality of autonomous vehicles, each to capture a plurality of photos with corresponding photo locations;
an image database to store each of the plurality of photos and corresponding photo locations as image entries; and
a central computer to:
receive a ride request including an input image, wherein the input image corresponds to one of a pick-up location, a stop location, and a drop-off location;
search the image database for a first image entry matching the input image; and
identify the first image entry and a first corresponding location, and determine an input image location based on the first corresponding location.

17. The system of claim 16, wherein the image database is further to store the input image and the input image location.

18. The system of claim 16, wherein the central computer is further to route a first autonomous vehicle from the plurality of autonomous vehicles to the input image location.

19. The system of claim 16, wherein the central computer receives the ride request from a ridehail application, and wherein the central computer is further to transmit a request for an additional input image to the ridehail application.

20. The system of claim 16, wherein the central computer receives the ride request from a ridehail application, and wherein the central computer is further to request confirmation of the input image location via the ridehail application.
